(19) United States
(12) Patent Application Publication
(10) Pub. No.: US 2024/0199397 A1
(43) Pub. Date: Jun. 20, 2024

(54) Device for delimiting a hoisting device

(71) Applicant: Deutsche Post AG, Bonn (DE)

(72) Inventor: Thomas HEINTZ, Leudersdorf (DE)

(21) Appl. No.: 18/390,430

(22) Filed: Dec. 20, 2023

(30) Foreign Application Priority Data
Dec. 20, 2022 (DE) 10 2022 134 183.6

(51) Int. Cl. B66F 9/18; B66F 9/075

(52) U.S. Cl. CPC B66F 9/18; B66F 9/07504; B66F 9/0755

(57) ABSTRACT

The invention relates to a device delimiting a hoisting device with at least two forks when picking up a transport load with at least one recess for the insertion of the forks with the hoisting device, wherein the device has a fastening means by which the device can be reversibly fastened to the forks, the device has a rear stop and the device is designed to limit the insertion depth when inserting the forks into the recess in an operational state by having the rear stop rest against the transport load in an inserted state. In this way, a possible way is provided of positioning the transport load on the hoisting device precisely and efficiently in terms of time that is both easy to handle and can also be used flexibly.

The invention relates to a device for delimiting a hoisting device with at least two forks when a transport load with at least one recess for the insertion of the forks is picked up using the hoisting device.

In logistics, hoisting devices are used for lifting and moving transport loads, such as pallets, containers, boxes or the like, for example. These hoisting devices are primarily floor handling devices. Floor handling devices are generally understood to mean conveying means for the horizontal transportation of transport loads, such as pallet jacks or forklifts, for example. The floor handling devices in this case can also be partially electric or fully electric and can be operated with or without a driver.

The hoisting devices typically have at least two forks with which the transport load can be picked up. The transport load has at least one recess or opening that matches the forks, into which the forks can be inserted. In this case, both forks are inserted into the same flat recess or opening. The transport load may have a lateral limit created by transport rollers, support feet or the like, for example.

If the forks are arranged beneath the transport load by inserting them into the recess or opening, the transport load can also be lifted by raising the forks. In the raised state, the transport load can then be moved in a horizontal direction.

Although the hoisting devices are generally used for transporting the transport loads, situations often arise, especially in logistics, in which work needs to be carried out on the transport load lifted by means of the hoisting device. These situations arise particularly with picking, when individual piece goods need to be removed from the transport load.

For example, in post and parcel logistics, situations often arise in which the piece goods or letters and/or parcels are transported in large containers or boxes. These letters and/or parcels have to be removed, sorted and/or reassigned for further processing. In order to be able to guarantee an ergonomic workflow, the transport loads are raised to an ergonomically advantageous height by means of a hoisting device, so that the individual piece goods can be processed with a back-friendly posture.

However, when working on the raised transport load, there are numerous hazards that make it substantially more difficult to guarantee occupational safety.

When picking up the transport load with the hoisting device, the insertion depth of the forks under or into the transport load cannot be monitored. This means that depending on the height and design of the transport load and the hoisting device, the operator of the hoisting device cannot see how far the forks are inserted under or into the transport load before lifting it. Typically, the forks are substantially longer than the transport load, so when they are inserted, the forks protrude until they reach the stop at the far end of the transport load. In the raised state, the tips of the forks protrude, posing a substantial risk of accidents and injuries. Similarly, the forks may also not be inserted far enough, so the transport load is not fully gripped and can tip or slip over the fork tips when lifted. These risks can be avoided by always inserting the forks exactly deep enough below or into the transport load, so that the fork tips extend to the furthest edge of the transport load and thereby align the base of the transport load with the fork tips. In this way, the fork tips do not protrude forwards and the transport load cannot tip over the fork tips either. This positioning of the forks beneath the transport load requires considerable precision. This precision is time-consuming, as the hoisting device operator must continuously monitor the position of the forks under the transport load before lifting it. Permanent modifications or additions to the hoisting devices that can address the aforementioned disadvantages are neither permitted nor achievable.

Based on this, the object of the invention is to provide a possible way of positioning the transport load on the hoisting device precisely and efficiently in terms of time that is both easy to handle and can also be used flexibly.

This object is achieved by the subject matter of Patent claim 1. Preferred developments can be found in the dependent claims.

According to the invention, a device for delimiting a hoisting device with at least two forks when picking up a transport load with at least one recess for the insertion of the forks with the hoisting device is provided, wherein the device has a fastening means by which the device can be reversibly fastened to the forks, the device is designed to limit the insertion depth when inserting the forks into the recess in an operational state by having the rear stop rest against the transport load in the inserted state.

In the present case, a hoisting device is understood to mean, in particular, a floor handling device. Floor handling devices generally include conveying means for the horizontal transportation of transport loads, such as pallet jacks or forklifts, for example. The hoisting device has at least two forks, often referred to as forks, with which a load can be raised.

In the present case, the transport load is understood to mean a pallet, a container trolley and/or a box, which allows for the simultaneous transportation of multiple individual piece goods.

When an “operational state” is referred to in the present case, this means the state in which the device is mounted on the hoisting device and fastened, and the system consisting of the hoisting device and the device for insertion under the load or into the recess in the transport load is ready. Accordingly, the “inserted state” is understood to mean the state in which the forks of the hoisting device, along with the device, are inserted beneath the transport load or into the recess of the transport load, and the hoisting device is ready to lift the load.

The device has a rear stop that limits the insertion depth of the forks under the transport load. The distance between the fork tips and the rear stop determines the insertion depth.

A significant point of the invention is that the original stop point can be shifted towards the transport load by means of the device, so that narrower loads can be securely picked up and precisely positioned, without the fork tips protruding or the transport load not being fully gripped. The device can easily be reversibly attached to the hoisting device and can be used flexibly. In the operational state, the forks are moved under the load until the transport load rests against the rear stop of the device. The distance between the fork tip and the rear stop can, in particular, be adjusted to the depth of the transport load in this case, making the device universally applicable.

According to a preferred development of the invention, the device has a front stop connected to the rear stop. More preferably, in the operational state, the front stop rests against a front tip of the forks. The front stop in this case may, in particular, be configured as an angle iron. The front stop rests against the fork tips and prevents a movement of the device in the longitudinal direction against the direction of movement of the hoisting device, in particular when the rear stop rests against the transport load when a transport load is being picked up and a force is applied to the device against the direction of movement. At the same time, the combination of the front and rear stops ensures that the device can be placed on any receiving devices and fastened, while maintaining the same insertion depth.

According to a preferred development of the invention, the rear stop and the front stop are connected by means of at least one longitudinal strut. More preferably, the longitudinal strut is arranged between the forks in the operational state. The length of the longitudinal struts defines the distance between the front stop and the rear stop and therefore the insertion depth of the hoisting device in the operational state. This distance can, in particular, be varied and individually adjusted to the depth of the load. The device preferably includes at least two longitudinal struts, wherein one longitudinal strut in each case rests on the inside of each fork. In this way, the longitudinal struts prevent movement of the device in the transverse direction. The longitudinal struts in this case are, in particular, geometrically dimensioned in such a way that, in the operational state, they are located in a planar plane with the surface of the forks and a flat surface for carrying the load can thereby be guaranteed.

According to a preferred development of the invention, the front stop has a securing edge designed to secure the transport load in the longitudinal direction in the inserted state. The front stop, which rests against the fork tips in the operational state, has, in particular, an edge that extends vertically upwards. This edge is preferably between 5 mm and 10 mm high and secures the transport load during lifting and work, preventing it from slipping over the fork tips, as the transport load is held back by the edge in the longitudinal direction.

According to a preferred development of the invention, the rear stop has at least one securing element that can be inserted into an opening in the transport load and is designed to secure the transport load in the transverse direction in the inserted state. The securing element of the device and an opening in the transport load that matches it together form a kind of plug-in system. When moving the hoisting device with the device in the direction of the transport load, the securing element is inserted into the corresponding opening in the transport load. This creates resistance when the transport load is moved in the transverse direction, so that the transport load is secured in the transverse direction.

The securing element is preferably wedge-shaped. “Wedge-shaped” in this context refers to a triangular structure, wherein a wide opening of the securing element faces towards the transport load to be taken hold of and the wedge-shaped securing element is formed such that it becomes narrower towards the rear, thereby making it more stable. This wedge-shaped form facilitates insertion into the opening in the transport load and, at the same time, provides stable securing against lateral forces.

It is preferably provided that the device has two securing elements that are arranged side by side and spaced apart from one another. In this way, even with a relatively large opening, movement of the transport load in both transverse directions can be prevented, as two spaced apart securing elements rest against the insides of the opening.

According to a preferred development of the invention, the securing element is pivotally mounted. “Pivotally mounted” means, in particular, that the securing element can be rotated about a rotational axis. The rotational axis may run horizontally or vertically. In both cases, a rotation of the securing element is made possible. This is particularly relevant in situations where the transport load does not have any matching openings, for example, when a box is placed on a pallet and the wedge-shaped securing means cannot therefore be used.

According to a preferred development of the invention, the fastening means comprises at least one magnet. The forks of a hoisting device are preferably made of magnetizable metal. Accordingly, the device can be fastened onto the forks by means of a magnet. The fastening means preferably comprises one magnet per fork, so that the device can be securely fastened to both forks. The magnets are, in particular, fixedly connected to the device, so that they are permanently integrated into the device for assembly and do not fall off or get lost.

The magnets preferably comprise switchable magnets. Switchable magnets with permanent magnets made of neodymium-iron-boron, for example, are constructions that, in a similar way to an electromagnet, allow switching between two magnetic states. A switch or lever is used to rotate the switchable magnet, so that the magnetic flux path in the construction changes. In the “on” state, the magnetic flux passes through the pole shoes. In the “off” state, the flux is internally redirected, so that the field lines do not pass via the pole shoes. In this way, the device can be mounted particularly easily on the hoisting device or on the forks. Assembly consists solely of positioning the device and activating the magnet by rotating an actuating device, so that the device is reversibly fixed on the forks.

According to a preferred embodiment of the invention, the magnet has a tensile force greater than 550 N, preferably greater than 600 N, quite particularly preferably greater than 650 N. If the magnet has a tensile force of 550 N, this means, in other words, that the connection between the magnet and fork, or the device and fork, is so stable that it can withstand a pull with a force of 550 N without becoming detached. A tensile force of approximately 667 N corresponds in this case to the weight force of a weight of 68 kg. The magnets are preferably arranged at the rear stop. The rear stop is, apart from the front limit provided by the angle iron adjacent to the forks, the point at which most of the force is applied, as the transport load is pressed against the rear stop when the forks are inserted. If the magnets are arranged at the rear stop, they secure the device directly at the point of application.

According to a preferred development of the invention, the device has at least one carrying handle for carrying and holding the device. The carrying handle in this case is particularly arranged at the rear stop and/or between the longitudinal struts of the device. This allows secure holding and guidance of the device during assembly. Assembly can, in particular, be carried out particularly quickly in that the front stop rests against the fork tips and the device with the carrying handle and magnets is lowered onto the forks. The front stop ensures a secure positioning of the device on the forks. The device can be fastened particularly easily by means of the magnets. In total, only two to three manual actions are therefore needed, in order to mount the device on the forks and create the operational state.

According to a preferred embodiment of the invention, the device has a tilting unit that is designed to tilt the transport load about a transverse axis and/or a longitudinal axis when in the inserted state. For this purpose, the tilting unit comprises a base unit that is fastened to the forks and a tilting device that is fastened to the base unit at a pivot point. The transport load is arranged on the tilting device. In an initial position, the tilting device is locked to the base unit. By unlocking, the tilting device can be rotated about the pivot point or pivot axis. In this case, the degree of rotation, in particular, is predetermined. Preferably, the tilting device can be rotated between 5° and 15°. The pivot axis is preferably oriented along the securing edge, so that when the transport load is tilted, slipping of the transport load over the fork tips can be avoided.

In this way, ergonomically improved working when manually removing piece goods from the transport load, such as from a container, for example, can be guaranteed. Therefore, it is not only made possible for users to lift the transport load to a reasonable working height with the help of the device, but tilting of the transport load towards the user by approximately 10 to 15 cm by means of the additional tilting unit at the front stop is also made possible. As a result of this, the transport load tilts slightly towards the user, making it easier to reach piece goods. When correctly positioned, there is no risk of the container slipping off due to the securing edge at the front stop.

The invention will be explained in further detail below with reference to the drawings with the help of a preferred embodiment.

In the drawings:

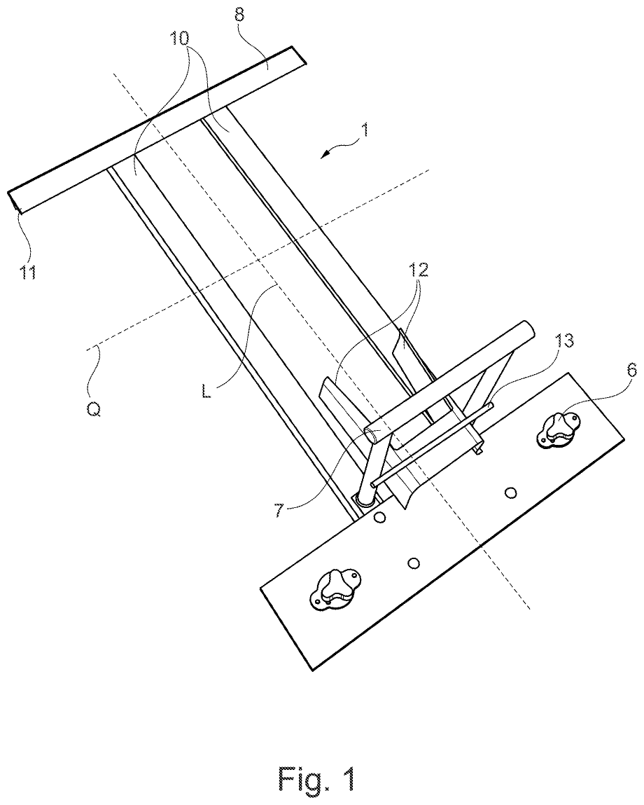

FIG. 1 schematically shows a device according to a preferred exemplary embodiment of the invention in a perspective view,

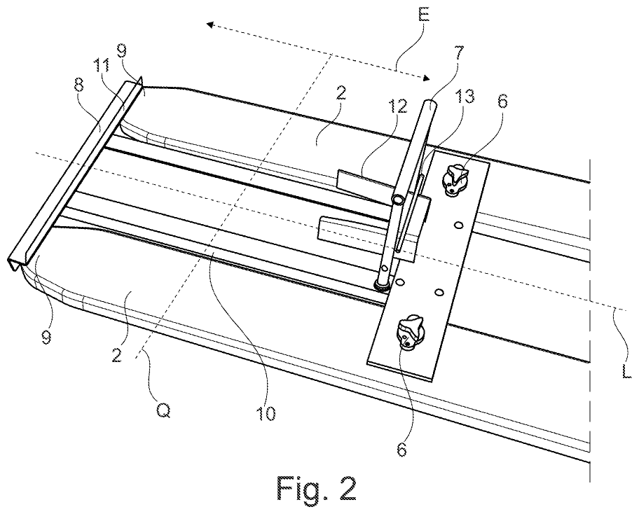

FIG. 2 schematically shows the device from FIG. 1 in an operational state in a perspective view,

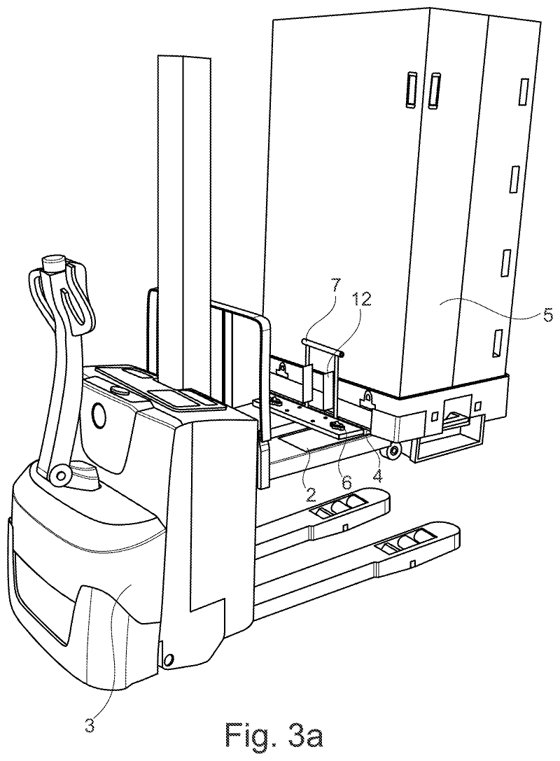

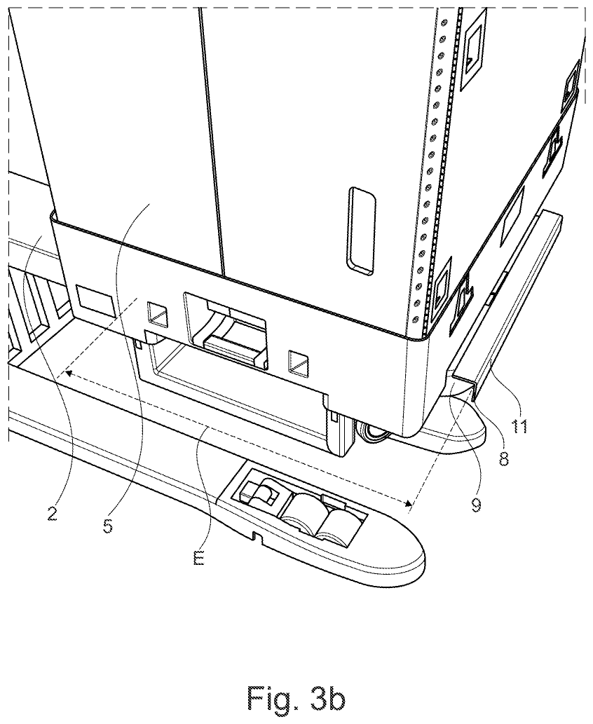

FIG. 3a schematically shows the device from FIG. 1 in an inserted state in a perspective rear view,

FIG. 3b schematically shows the device from FIG. 1 in an inserted state in a perspective front view.

In FIG. 1, a device 1 according to a preferred exemplary embodiment of the invention is schematically shown in a perspective view. The device 1 has a rear stop 7 and a front stop 8. The front stop 8 and the rear stop 7 are connected to one another via two longitudinal struts 10. At the rear stop 7, there is a carrying handle 13 that can be used to carry and position the device 1. In addition, at the rear stop 7 there are two fastening means 6 in the form of controllable magnets and two securing elements 12 that can be inserted into the load 5 in addition. The front stop 8 comprises a securing edge that allows the device 1 to be placed against the fork tips 9.

FIG. 2 shows the device 1 from FIG. 1 in an operational state. The operational state is achieved by mounting or fastening the device 1 to the forks 2 of a hoisting device 3. For this purpose, the front stop 8 is placed against the fork tips 9. The device 1 can be positioned by means of the carrying handle 13. The rear stop 7, together with the fastening means 6, is lowered onto the forks 2 and fastened. The length of the longitudinal struts 10 determines the subsequent insertion depth E. The length of the longitudinal struts 10 is adjusted to the depth of the transport load 5, so that the transport load 5 can be optimally accommodated. A movement of the device 1 in the longitudinal direction L is prevented by the front stop 8 and the fastening means 6. A movement of the device 1 in the transverse direction Q is prevented by the longitudinal struts 10, which are arranged between the forks 2. In this way, the device 1 is held on the forks 2 not only via the fastening means 6, but also via the geometry itself. In this operational state as shown, the device 1 can be used to lift a transport load. This state is shown in FIGS. 3a and 3b.

FIG. 3a shows the device 1 in the inserted state in this case in a perspective rear view. The hoisting device 3 was moved with the forks 2 and the device 1 towards the transport load 5. The forks 2 in this case were inserted into the recess 4 of the transport load 5 until the transport load 5 abuts against the rear stop 7 of the device 1, thereby limiting the insertion depth E. In the case shown, the securing elements 12 have been folded away to the side since the transport load 5 does not have any suitable openings for inserting the securing elements 12.

In FIG. 3b, the same situation as in FIG. 3a is shown from a different perspective. It can be seen that the device 1 is resting against the fork tips 9 with the front stop 8. This prevents the device from moving against the direction of movement of the forks 2 when the forks 2 are inserted. The forks 2 are inserted until the transport load 5 rests against the rear stop 7 and the front end of the transport load 5 ends flush with the front stop 8 or the fork tips 9. In this state, the transport load 5 is secured in the longitudinal direction by the rear stop 7 and the front stop 8 or the securing edge 11. The insertion depth E is therefore determined by the spacing of the rear stop 7 and the front stop 8 and is adapted to the depth of the transport load 5.

FIGS. 3a and 3b show the device 1 in the inserted state with the transport load 5 lifted. In this position, safe working on the lifted load 5 is possible, since the transport load 5 is secured and slippage from the forks 2 is avoided. Moreover, there are no fork tips 9 protruding. The process of picking up the transport load 5 is also time-saving and simple, as the device 1 can be fastened to the forks 2 simply and reversibly with a few manual actions. After that, the transport load 5 can be picked up with the forks 2 as usual. Only the rear stop of the hoisting device 3 is displaced towards the transport load 5 by the rear stop 7 of the device 1.

In addition, tilting the transport load 5 forwards by rotation about a transverse axis or sideways by rotation about a longitudinal axis is possible by means of a tilting unit, in order to further improve working on the lifted transport load 5 and simplify access to the contents of the transport load 5.

### LIST OF REFERENCE SIGNS

1 device
2 forks
3 hoisting device
4 recess
5 transport load
6 fastening means
7 rear stop
8 front stop
9 fork tip
10 longitudinal strut
11 securing edge
12 securing clement
13 carrying handle
E insertion depth
L longitudinal direction
Q transverse direction

1. Device for delimiting a hoisting device with at least two forks when picking up a transport load with at least one recess for the insertion of the forks with the hoisting device, wherein
the device has a fastening means by which the device can be reversibly fastened to the forks,
the device has a rear stop and
the device is designed to limit the insertion depth when inserting the forks into the recess in an operational state by having the rear stop rest against the transport load in an inserted state.

2. Device according to claim 1, wherein the device has a front stop connected to the rear stop and the front stop rests against a front tip of the forks in the operational state.

3. Device according to claim 2, wherein the rear stop and the front stop are connected by means of at least one longitudinal strut and the longitudinal strut is arranged between the forks in the operational state.

4. Device according to claim 2, wherein the front stop has a securing edge designed to secure the transport load in the longitudinal direction in the inserted state.

5. Device according to claim 1, wherein the rear stop has at least one securing element that can be inserted into an opening in the transport load and is designed to secure the transport load in the transverse direction in the inserted state.

6. Device according to claim 1, wherein the securing element is pivotally mounted.

7. Device according to claim 1, wherein the fastening means comprises at least one magnet.

7. Device according to claim 7, wherein the magnet has a tensile force greater than 550 N.

9. Device according to claim 1, wherein the device has at least one carrying handle for carrying and holding the device.

10. Device according to claim 1, wherein the device has a tilting unit that is designed to tilt the transport load about a transverse axis and/or a longitudinal axis when in the inserted state.

11. Device according to claim 7, wherein the magnet has a tensile force greater than 600 N.

12. Device according to claim 7, wherein the magnet has a tensile force greater than 650 N.
